(19) United States
(12) Patent Application Publication
(10) Pub. No.: US 2012/0138566 A1
(43) Pub. Date: Jun. 7, 2012

(54) Method for Lithography Etching a Glass Substrate by Miniature Balls

(75) Inventors: Chao-Nan Wei, Taoyuan County (TW); Hui-Yun Bor, Taoyuan County (TW); Kuan-Zong Fung, Taoyuan County (TW); Meng-Hung Tsai, Taoyuan County (TW)

(73) Assignee: Chung-Shan Institute of Science and Technology, Armaments, Bureau, Ministry of National Defense, Taoyuan County (TW)

(21) Appl. No.: 13/192,430

(22) Filed: Jul. 27, 2011

(30) Foreign Application Priority Data
Dec. 2, 2010 (TW) 099141853

(51) Int. Cl. C03C 15/00; C23F 1/02; B82Y 40/00

(52) U.S. Cl. 216/13; 216/41; 977/888

(57) ABSTRACT

Disclosed is a method for lithography etching a glass substrate. The method includes the steps of providing a glass substrate, providing miniature balls on the glass substrate so that the miniature balls become an etching-resistant layer, etching the glass substrate covered by the miniature balls to make a miniature pattern on the glass substrate, and removing the miniature balls from the substrate.

### BACKGROUND OF INVENTION

1. Field of Invention

The present invention relates to a solar cell and, more particularly, to a method for lithography etching a glass substrate for use in a solar cell that increases the conversion rate of the solar cell by increasing scattering but reducing reflection.

2. Related Prior Art

The conversion rate of a solar cell is a crucial factor for the success of the solar cell. To increase the conversion rate, the absorption rate of the absorption layer of the solar cell or the conductivity of the solar cell may be increased or the better materials may be used. Since we are running out of silicon, it is important to reduce the consumption of silicon. Hence, there is a trend to develop amorphous or miniature crystalline thin-film solar cells based on inexpensive glass substrates. However, not all sun light cast on such a solar cell is absorbed by the absorption layer, which is generally only several micrometers thick. It is hence an important thing to increase the absorption rate in the absorption layer. Moreover, the scattering of the sun light in such a solar cell can be increased and the reflection of the sun light from such a solar cell can be reduced to improve the conversion rate of such as solar cell.

To increase the scattering, the surface of the transparent conductive layer of such a solar cell is made rough so that sun light scatters when it travels through the surface of the transparent conductive layer. The roughness is made on the surface of the transparent conductive layer by vapor deposition or etching for example. Different parameters of the vapor deposition result in different degrees of roughness. However, chemical vapor deposition always requires expensive equipment and produces toxic gases such as HCl and HF. The roughness made by chemical vapor deposition is limited.

To reduce the reflection, at least one anti-reflection layer can be provided on the transparent conductive layer. If there is only one anti-reflection layer, the anti-reflection layers is often made of materials with refraction rates of 1.8 to 1.9. If there are several anti-reflection layers, the reflection is reduced by the anti-reflection layers with different reflection rates. However, the amount of the light into such a solar cell is reduced as the number of the anti-reflection layers is increased. There have been some attempts to make pyramid-like elements on crystalline silicon by lithography etching to achieve multi-reflection on the surface of the crystalline silicon. It is however difficult to provide pyramid-like elements on a thin layer of amorphous or microcrystalline silicon by etching.

In the semiconductor industry, lithography etching is substantially optical lithography etching. The resolution of the optical lithography is limited. It is commonly recognized that the optical lithography is difficult with a line that is smaller than 1 micrometer thick. Optical lithography based on extreme ultraviolet light, iron beam projection lithography or X-ray lithography. These techniques are however extremely complicated and expensive.

The present invention is therefore intended to obviate or at least alleviate the problems encountered in prior art.

### SUMMARY OF INVENTION

It is the primary objective of the present invention to increase the conversion rate of a solar cell by increasing the scattering of light in the solar cell and reducing the reflection of the light from the solar cell.

To achieve the foregoing objective, the method includes the steps of providing a glass substrate, providing miniature balls on the glass substrate so that the miniature balls become an etching-resistant layer, etching the glass substrate covered by the miniature balls to make a miniature pattern on the glass substrate, and removing the miniature balls from the substrate.

In an aspect, the miniature balls are made of SiO₂, PMMA or PS.

In another aspect, the diameter of the miniature balls is 10 nanometers to 20 micrometers.

In another aspect, the etching of the glass substrate is selective reactive ion etching.

In another aspect, the transverse dimension of the patter is 20 nanometers to 10 micrometers, and the depth of the roughness is 20 nanometers to 10 micrometers.

In another aspect, the miniature pattern includes a transverse dimension of 20 nanometers to 10 micrometers and a depth of 20 nanometers to 10 micrometers. In another aspect, the miniature pattern includes cones with a transverse dimension of 20 nanometers to 10 micrometers and a depth of 20 nanometers to 10 micrometers.

In another aspect, the miniature pattern includes semi-spheres with a transverse dimension of 20 nanometers to 10 micrometers and a depth of 20 nanometers to 10 micrometers.

In another aspect, the miniature pattern includes lenses with a transverse dimension of 20 nanometers to 10 micrometers and a depth of 20 nanometers to 10 micrometers.

In another aspect, the method further includes the step of providing a transparent conductive layer on the miniature pattern.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a perspective view of miniature balls for use in a method for lithography etching a glass substrate used in a solar cell according to the preferred embodiment of the present invention;

FIG. 2 is a perspective view of a glass substrate provided with the miniature balls shown in FIG. 1;

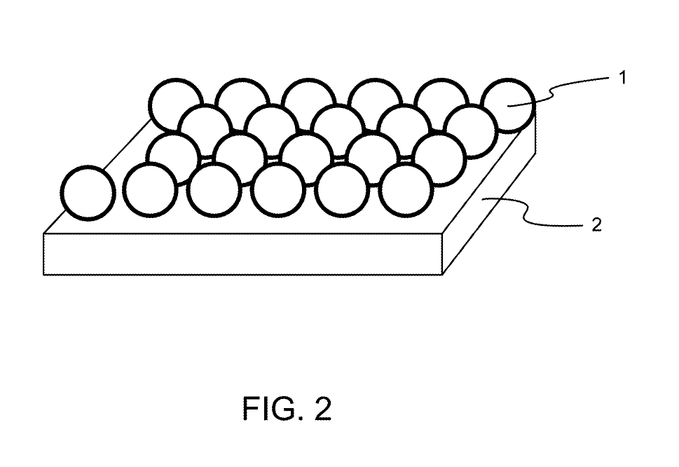

FIG. 3 is a perspective view of roughness made on the glass substrate shown in FIG. 2;

FIG. 4 is a perspective view of a type of roughness made on the glass substrate shown in FIG. 2;

FIG. 5 is a perspective view of another type of roughness than shown in FIG. 4; and

FIG. 6 is a perspective view of another type of roughness than shown in FIG. 5.

### DETAILED DESCRIPTION OF PREFERRED EMBODIMENT

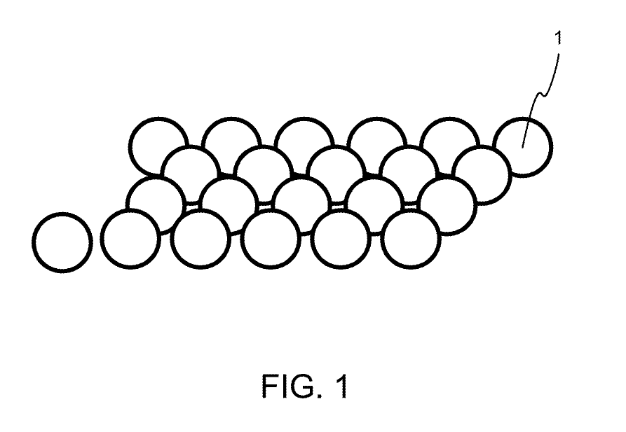

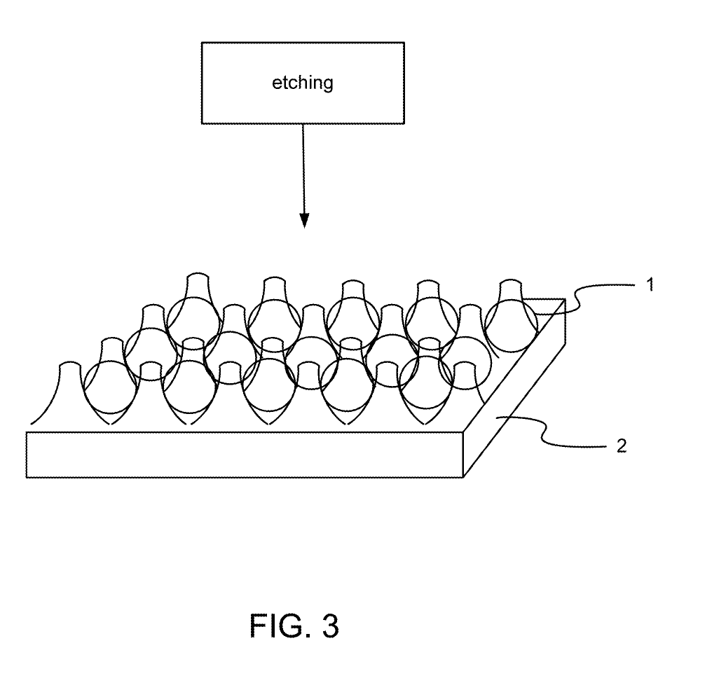

Referring to FIGS. 1 and 3, there is shown a method for lithography etching a glass substrate for use in a solar cell according to the preferred embodiment of the present invention. At first, miniature balls 1 are provided. The miniature balls 1 may be made of SiO₂, PMMA or PS. The diameter of the miniature balls 1 is 10 nanometers to 20 micrometers.

Secondly, there is provided a glass substrate 2. The miniature balls 1 are located on the glass substrate 2. The miniature balls 1 become an etching-resistant layer on the glass substrate 2.

Thirdly, the glass substrate 2 provided with the miniature balls 1 is subjected to reactive ion etching such as RIE and ICP. Thus, selective etching is done on the glass substrate 2.

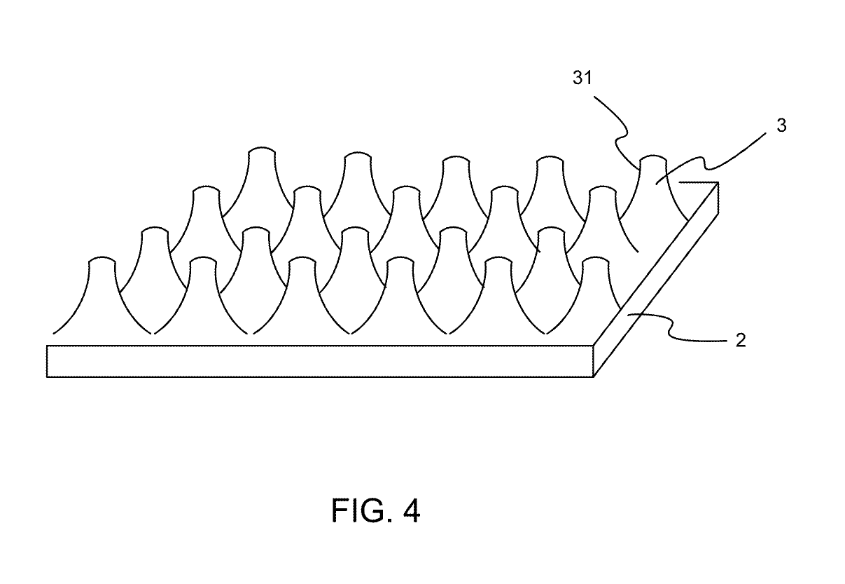

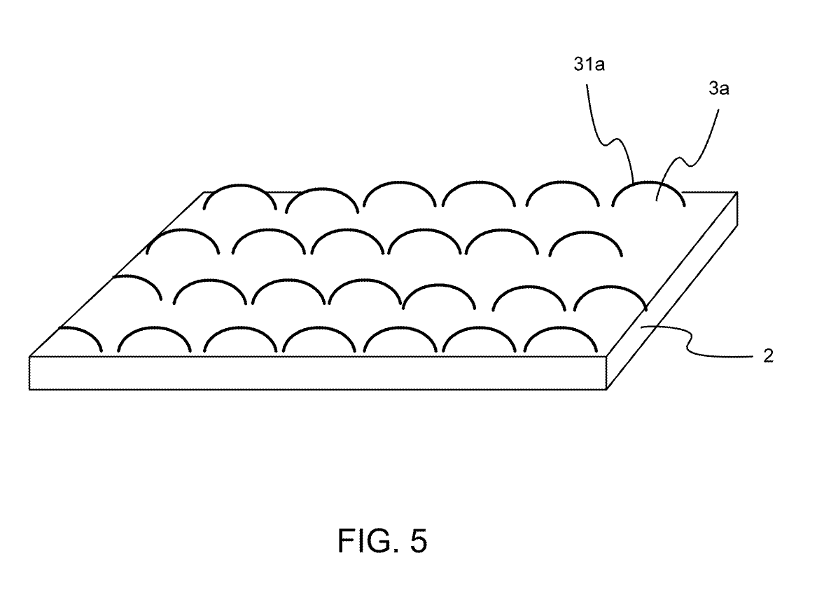

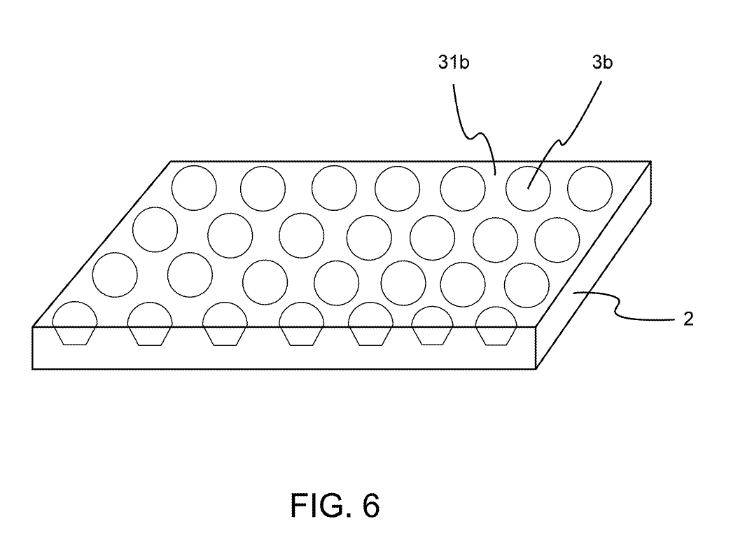

Fourthly, the miniature balls 1 are removed from the glass substrate 2. Thus, roughness is made on the glass substrate 2. The roughness may be made in the form of cones 3 as shown in FIG. 4. Alternatively, the roughness may be made in the form of semi-spheres 3a referring to FIG. 5. Alternatively, the roughness may be made in the form of lenses 3b as shown in FIG. 6. The cones 3, semi-spheres 3a or lenses 3b is coated with a transparent conductive layer 31, 31a or 31b, respectively. The transverse dimensions of the cones 3, semi-spheres 3a or lenses 3b are 20 nanometers to 10 micrometers, and the depth of the roughness is 20 nanometers to 10 micrometers.

As discussed above, the cones 3, semi-spheres 3a or lenses 3b are made on the glass substrate 2 by using the miniature balls 1 in lithography etching. With the cones 3, semi-spheres 3a or lenses 3b, the scattering of light in a solar cell based on the glass substrate 2 is increased and the reflection of the light from the solar cell is reduced. Thus, the absorption rate of the light in the absorption layer of the solar cell is increased. Hence, the conversion rate of the light into electricity in the solar cell is increased. The shape of the roughness is determined according to the wavelengths of light to be absorbed by the solar cell.

With the method of the present invention, the scattering of light in the solar cell based on the glass substrate 2 is increased but the reflection of the light from the solar cell is reduced. Thus, the absorption rate of the light in the absorption layer of the solar cell is increased. Hence, the conversion rate of the light into electricity in the solar cell is increased. Furthermore, the method of the present invention is simple and inexpensive.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A method for lithography etching a glass substrate including the steps of:
providing a glass substrate 2;
providing miniature balls 1 on the glass substrate 2 so that the miniature balls 1 become an etching-resistant layer;
etching the glass substrate 2 covered by the miniature balls 1 to make a miniature pattern on the glass substrate 2; and
removing the miniature balls 1 from the substrate 2.

2. The method according to claim 1, wherein the miniature balls 1 are made of a material selected from the group consisting of SiO₂, PMMA and PS.

3. The method according to claim 1, wherein the diameter of the miniature balls 1 is 10 nanometers to 20 micrometers.

4. The method according to claim 1, wherein the etching of the glass substrate 2 is selective reactive ion etching.

5. The method according to claim 1, wherein the miniature pattern includes a transverse dimension of 20 nanometers to 10 micrometers and a depth of 20 nanometers to 10 micrometers.

6. The method according to claim 1, wherein the miniature pattern includes cones 3 with a transverse dimension of 20 nanometers to 10 micrometers and a depth of 20 nanometers to 10 micrometers.

7. The method according to claim 1, wherein the miniature pattern includes semi-spheres 3a with a transverse dimension of 20 nanometers to 10 micrometers and a depth of 20 nanometers to 10 micrometers.

8. The method according to claim 1, wherein the miniature pattern includes lenses 3b with a transverse dimension of 20 nanometers to 10 micrometers and a depth of 20 nanometers to 10 micrometers.

9. The method according to claim 1, further including the step of providing a transparent conductive layer on the miniature pattern.
